(19) United States
(12) Patent Application Publication
(10) Pub. No.: US 2016/0205953 A1
(43) Pub. Date: Jul. 21, 2016

(54) Cake Icing Device

(71) Applicant: Tuong D. Nguyen, Waxhaw, NC (US)

(72) Inventor: Tuong D. Nguyen, Waxhaw, NC (US)

(21) Appl. No.: 14/600,697

(22) Filed: Jan. 20, 2015

(51) Int. Cl. A21D 13/00; A23P 1/08; A21D 13/08

(52) U.S. Cl. CPC A21D 13/0061; A21D 13/08; A23P 1/085

(57) ABSTRACT

A cake icing device comprising a stationary circular base designed to support a cake covered with icing; a support arm detachably attached to the circular base and terminates at a center point above the cake; a center pivot member designed to operationally engage the support arm; a horizontal icing member designed to engage the center pivot member and to rotate radially above the cake; and a vertical icing member detachably attached to the horizontal icing member being designed to circle the cake. The user moves the horizontal icing member and the vertical icing member about the cake to engage the cake icing in order to smooth or add decorative features to the cake icing.

### FIELD OF THE INVENTION

The present invention relates to a cake icing device that facilitates the smoothing of icing applied to the top and side surfaces of a cake. Additionally, the present invention can be used to add certain decorative features to the layer of icing applied to the surfaces of a cake.

### BACKGROUND OF THE INVENTION

The decoration of baked goods with icing is often desired for informal home consumption, as well as formal special occasions and business functions. Decorating baked goods, such as cakes, with icing at home by the non-professional homemaker is often a tedious, time consuming task that must be done by hand. The manual labor required by the homemaker to apply icing to a cake limits both the number of cakes that a homemaker can produce, as well as the uniformity of the appearance and aesthetics of the icing layer from cake to cake. In a commercial environment there is generally an abundant supply of commercially decorated baked goods due to mass production by industrial grade equipment and machinery that is utilized for producing such goods. The mechanical application of cake icing in the commercial environment also provides a more consistent and repeatable layer of icing when producing such baked goods on a large scale. The commercial grade equipment used in both large and small baking facilities is typically a complex mechanical device that requires professional operation and maintenance. Additionally, such commercial equipment is costly and generally occupies space that is dedicated exclusively for the operation of the cake icing equipment. In light of the characteristics of cake icing equipment in the commercial environment, such equipment is not available, nor adaptable, for use by the homemaker for applying icing to the occasional cake.

Accordingly, there remains room for improvement and variation within the art.

### SUMMARY OF THE INVENTION

The invention therefore provides an economical cake icing device that is simple to use and simple to maintain.

It is at least one aspect of the present embodiments to provide a cake icing device comprising a stationary circular base, a support arm, a center pivot member, a horizontal icing member, and a vertical icing member. The circular base includes a top side, a bottom side, a vertical side wall connecting the top side and the bottom side of the circular base, a perimeter, and a center point. The circular base is designed to support a cylindrical cake having a top surface and a side surface with each of the cake surfaces being covered with a layer of icing. The support arm is detachably attached to the perimeter of the circular base and terminates at a center axis above the cake. The support arm comprising a vertical support member having a proximal end and a distal end and a horizontal support member with a proximal end engaged to the distal end of the vertical support member and a distal end located at the center axis above the cake. The center pivot member is designed to operationally engage the distal end of the horizontal support member of the support arm and is vertically aligned with the center axis and the center point of the circular base. The horizontal icing member is operationally designed to engage the center pivot member and to rotate radially above the cake and includes a first icing blade which has a first icing edge and a first support element. The first icing edge of the first icing blade is designed to engage the layer of icing on the top surface of the cake. The vertical icing member being detachably attached to the horizontal icing member includes a second icing blade and a guiding means. Similar to the first icing blade, the second icing blade includes a second icing edge and a second support element. The vertical icing member is designed to circle the cake to engage the layer of icing on the side surface of the cake. The first icing edge and the second icing edge may have one of a variety of shapes to produce different decorative features on the layer of icing of the top and side surfaces of the cake.

It is at least one aspect of the present embodiments to provide a plurality of annular grooves radiating from the center point on the top side of the circular base, the annular grooves being configured to engage the guiding means on the vertical icing member.

It is at least one aspect of the present embodiments to provide a female fastening means operationally designed to detachably attach the proximal end of the vertical support member of the support arm to the vertical side wall of the circular base.

It is still a further aspect of at least one of the present embodiments to provide a support pivot ring located at the distal end of the horizontal support member.

It is at least one aspect of the present embodiments to provide a male fastening means located at the proximal end of the vertical support member that is operationally designed to engage the female fastening means on the circular base.

It is a least once aspect of the present embodiments to provide a center pivot member comprising a top end, a bottom end, a plurality of horizontal height adjustment apertures being vertically aligned from the top end to the bottom end of the center pivot member, a height adjustment pin, a horizontal retaining pin aperture located at the bottom end of the center pivot member, and a retaining pin. The height adjustment pin is operationally designed to be received by one of the horizontal apertures in order to engage the support pivot ring when raising or lowering the center pivot member. Additionally, the horizontal retaining pin aperture is operationally designed to receive the retaining pin in order to secure the horizontal icing member.

It is still a further aspect of at least one of the present embodiments to provide a horizontal icing member comprising a pivot ring operationally designed to engage the center pivot member and a pair of parallel prongs extending laterally from the pivot ring. The first prong of the parallel pair of prongs has a horizontal slot extending laterally from the pivot ring. The horizontal slot is configured to receive the first support element of the first icing blade and is closed at the pivot ring. The second prong of the pair of parallel prongs has a plurality of horizontally aligned notches operationally designed to engage the vertical icing member.

It is still a further aspect of at least one of the present embodiments to provide a vertical icing member comprising a top end, a bottom end, a vertical channel, and a plurality of vertically aligned height adjustment hooks. The vertical channel extends from the top end of the vertical icing member to the bottom end of the vertical channel. The vertical channel is open at its top end to receive the second support element of the second icing blade and closed at the bottom end to secure the icing blade in the vertical channel. The vertically aligned height adjustment hooks are operationally designed to engage the notches on the second prong of the horizontal icing member when detachably attaching the horizontal icing member to the vertical icing member.

It is a least once aspect of the present embodiments to provide a guiding means that is incorporated into the bottom end of the vertical icing member and is operationally designed to engage one of the plurality of annular grooves located on the top side of the circular base. The guiding means include, but is not limited to, a tapered bottom end, a wheel, and a roller bearing,

It is still a further aspect of at least one of the present embodiments to provide for a method of using a cake icing device comprising the steps of providing a stationary circular base being designed to support a cylindrical cake having a top surface and a side surface with each of the surfaces being covered with a layer of icing, the circular base having a perimeter, a center point, a top side, a bottom side, and a vertical side wall connecting the top side and bottom side, and a female fastening means operationally designed to detachably attach the proximal end of the vertical support member of the support arm to the vertical side wall of the circular base, wherein the top side of the circular base having a plurality of annular grooves radiating from the center point of the circular base; a support arm detachably attached to the perimeter of the circular base and designed to terminate at a center axis above said cake, the support arm comprising a vertical support member with a proximal end and a distal end and a horizontal support member with a proximal end engaged to the distal end of the vertical support member and a distal end located at the center axis above the cake, a support pivot ring located at the distal end of the horizontal support member, and a male fastening means located at the proximal end of the vertical support member being operationally designed to engage the female fastening means on the circular base; a center pivot member comprising a top end, a bottom end, a plurality of horizontal height adjustment apertures being vertically aligned from the top end to the bottom end of the center pivot member, a height adjustment pin being operationally designed to be received by one of the horizontal height adjustment apertures to engage the support pivot ring to raise or lower the center pivot member, a horizontal retaining pin aperture located at the bottom end of the center pivot member, the horizontal retaining pin aperture being operationally designed to receive a retaining pin, wherein said center pivot member being designed to operationally engage the distal end of the horizontal support member and being vertically co-aligned with the center axis and the center point of the circular base; a bifurcated horizontal icing member operationally designed to engage the center pivot member and to rotate radially above the cake and having a first icing blade which includes a first icing edge and a first support element, said first icing edge of the first icing blade being designed to engage the layer of icing on the top surface of the cake, a pivot ring operationally designed to engage the center pivot member, a pair of parallel prongs extending laterally from the pivot ring, a first prong of said pair of parallel prongs being designed to receive the first icing blade, a horizontal slot extends laterally from the pivot ring and being configured to receive the first icing support element of the first icing blade, the horizontal slot being closed at the pivot ring, and a second prong of said parallel pair of prongs having a plurality of horizontally aligned notches; a vertical icing member being designed to circle the cake to engage the layer of icing on the side surface of the cake and being detachably attached to the horizontal icing member, said vertical icing member comprising a second icing blade which includes a second icing edge and a second support element, a top end, a bottom end, a plurality of vertically aligned height adjustment hooks designed to engage a selected notch on the second prong of the horizontal icing member, a vertical channel traversing the length of the vertical icing member, the channel being open at the top end of the vertical icing member to receive the support element of the second icing blade and closed at the bottom end of the vertical icing member to secure the second icing blade within the channel, and a guiding means incorporated into the bottom end of the vertical icing member being operationally designed to engage one of the annular grooves, wherein the guiding means of said vertical icing member includes, but is not limited to, a tapered bottom end of the vertical icing member, a wheel, and a roller bearing; applying a layer of icing to the top surface and to the side surface of a cylindrical cake; aligning and placing the cylindrical cake on the center point of the circular base; selecting and securing a first icing blade to the horizontal icing member; selecting and securing a second icing blade to the vertical icing member; adjusting the height of the horizontal icing member to permit the first icing edge of the first icing blade to contact the layer of icing on the top surface of the cylindrical cake; adjusting the position of the vertical icing member to permit the second icing edge of the second icing blade to contact the layer of icing on the side surface of the cylindrical cake; and rotating the center pivot member so that the first icing edge of the first icing blade of the horizontal icing member rotates radially to engage the layer of icing on the top surface of the cake and the second icing edge of the second icing blade circles the cake to engage the layer of icing on the side of the cake.

These and other features, aspects, and advantages of the present invention will become better understood with reference to the following description and appended claims.

### BRIEF DESCRIPTION OF THE DRAWINGS

These and other features, aspects, and advantages of the present invention will become better understood with regard to the following description, appended claims, and accompanying drawings where:

FIG. 1 is a side view illustrating a cake icing device;

FIG. 2A is top plan view of a circular base;

FIG. 2B is a side view of a circular base;

FIG. 2C is a cross sectional side view a circular base;

FIG. 3A is perspective view illustrating a support arm;

FIG. 3B is a side view of a support arm;

FIG. 4A is a perspective view illustrating a center pivot member including a height adjustment pin and a retaining pin;

FIG. 4B is a side view of a center pivot member including a height adjustment pin and a retaining pin;

FIG. 4C is a front view of a center pivot member including a height adjustment pin and a retaining pin;

FIG. 5 is an exploded perspective view illustrating a horizontal icing member and a first icing blade;

FIG. 6A is a perspective view illustrating a vertical icing member; and

FIG. 6B is an exploded side view of a vertical icing member and a second icing blade.

### DETAILED DESCRIPTION OF THE INVENTION

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention.

In describing the various figures herein, the same reference numbers are used throughout to describe the same material, apparatus, or process pathway. To avoid redundancy, detailed descriptions of much of the apparatus once described in relation to a figure may not be repeated in the descriptions of subsequent figures, although such apparatus or process is labeled with the same reference numbers.

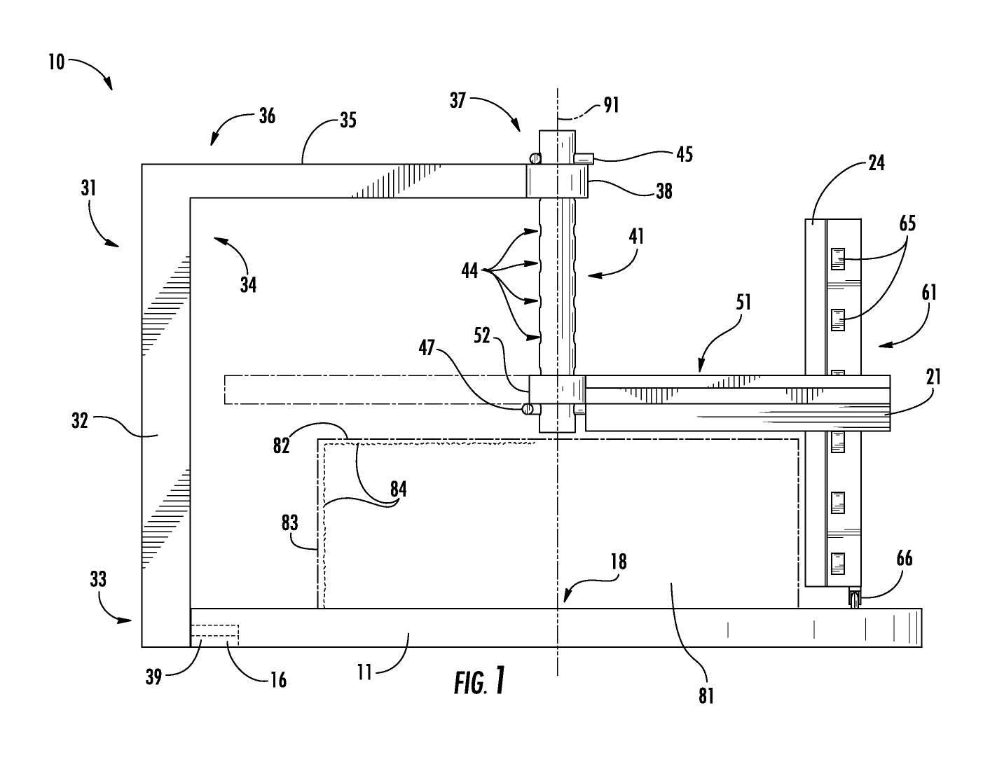

A cake icing device 10 for smoothing the layer of icing 84 on a cylindrical cake 81 is illustrated in FIGS. 1 to 6. The design of the cake icing device facilitates its economical manufacture completely from plastic materials, or a combination of plastic, light-weight metal, and rubber. The user of the cake icing device 10 may also add certain decorative features to the cake's layer of icing 84 as part of the smoothing process. In accordance with the present invention, a cake icing device 10 is illustrated in FIGS. 1 to 6 comprising a stationary circular base 11 designed to support a cylindrical cake 81, a support arm 31 that is detachably attached to the circular base 11 and terminates at a center axis 91 above the cake 81, a center pivot member 41, a horizontal icing member 51, and a vertical icing member 61 that includes a guiding means 66. To facilitate the assembly and disassembly of the present invention the support arm 31 is detachably attached to the circular base 11 with conventional male-female type fasteners. These fasteners include, but are not limited to, a simple snap fastener configuration or a simple thumb-screw fastener configuration such that the support arm 31 can be attached to, or detached from, the circular base 11 by hand and without the need of tools.

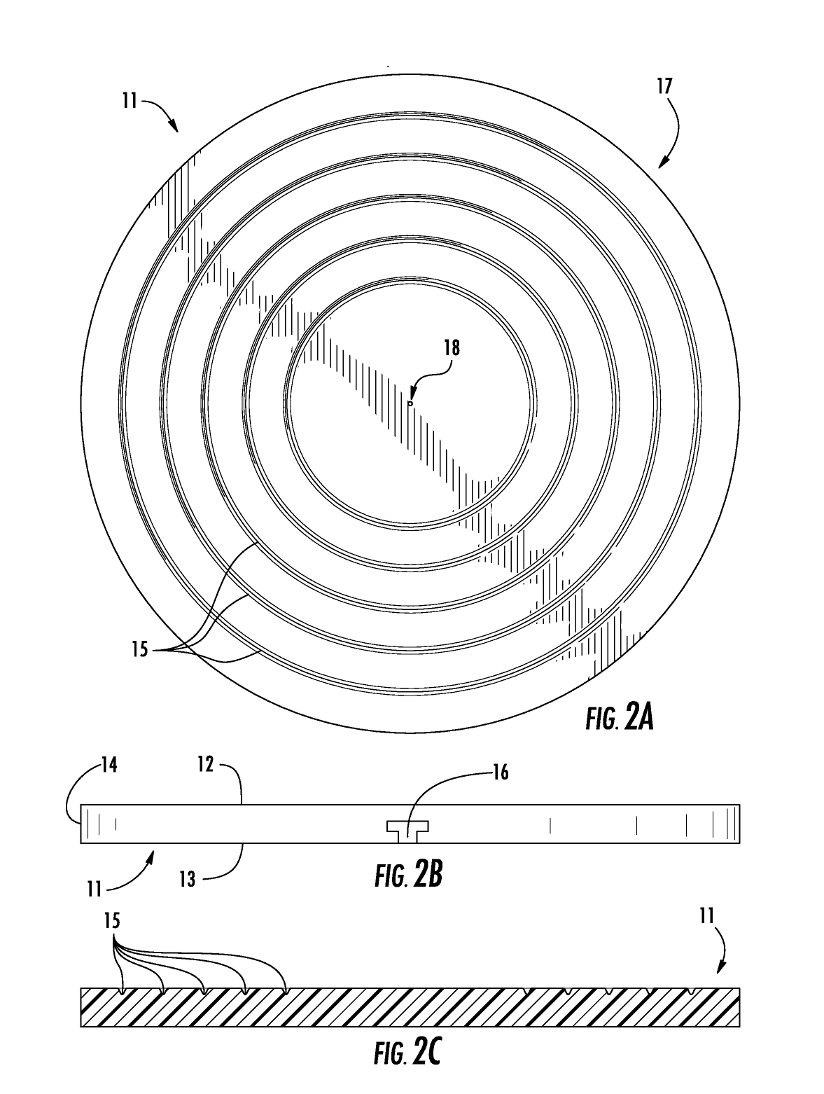

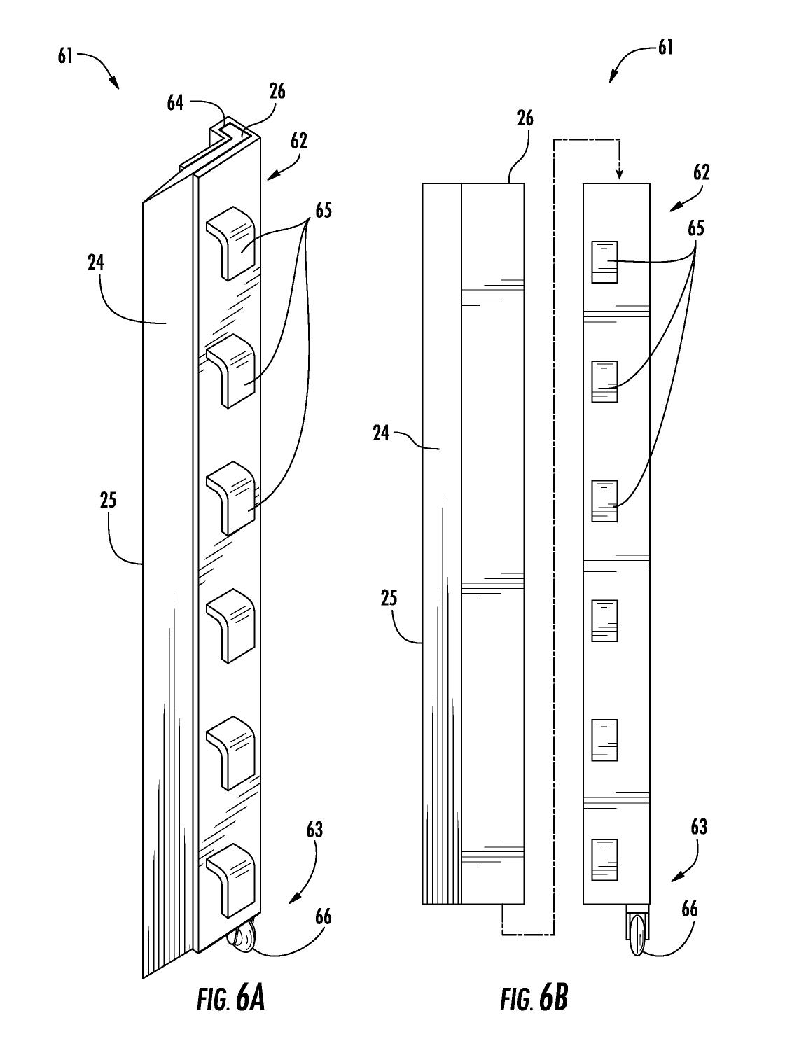

Now referring to FIGS. 1, 2A, 2B, and 2C, a preferred embodiment of the present invention includes a stationary circular base 11 having a perimeter 17 and a center point 18. The circular base 11 being designed to support a cylindrical cake 81 with a top surface 82 and a side surface 83 with both of the cake surfaces 82, 83 being covered with a layer of icing 84. FIGS. 2A, 2B, and 2C illustrate the circular base 11 further comprising a top side 12 having a plurality of annular grooves 15 radiating from the center point 18 of the circular base 11, a bottom side 13, a vertical side wall 14 connecting the top side 12 and the bottom side 13 of the circular base 11, and a female fastening means 16. The annular grooves 15 specifically shown in FIGS. 2A and 2C being configured to engage the guiding means 66 located at the bottom end 63 of the vertical icing member 61 illustrated in FIGS. 1, 6A, and 6B. Referring to FIGS. 1, 2A, and 2B, the female fastening means 16 being operationally designed to detachably attach the proximal end 33 of the vertical support member 32 of the support arm 31 to the vertical side wall 14 of the circular base 11.

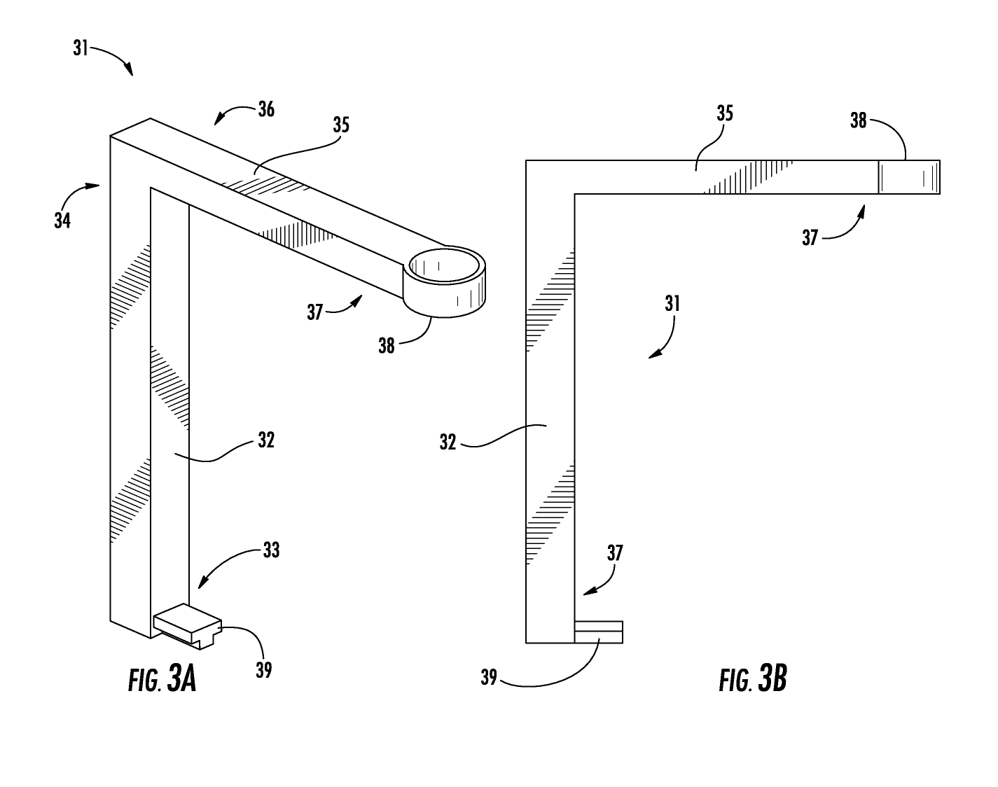

FIGS. 1, 3A, and 3B illustrate a support arm 31 that detachably attaches at the perimeter 17 of the circular base 11 and is designed to terminate on the center axis 91 above the cake 81. The support arm 31 comprising a vertical support member 32 with a proximal end 33 and a distal end 34, a horizontal support member 35 having a proximal end 36 engaged to the distal end 34 of the vertical support member 32, and a distal end 37 located on the center axis 91 above the cake 81. Continuing to refer to FIGS. 1, 3A, and 3B, the support arm 31 further comprising a support pivot ring 38 that is located at the distal end 37 of the horizontal support member 35. The support arm 31 also includes a male fastening means 39 located at the proximal end 33 of the vertical support member 32 which is operationally designed to engage the female fastening means 16 on the circular base 11.

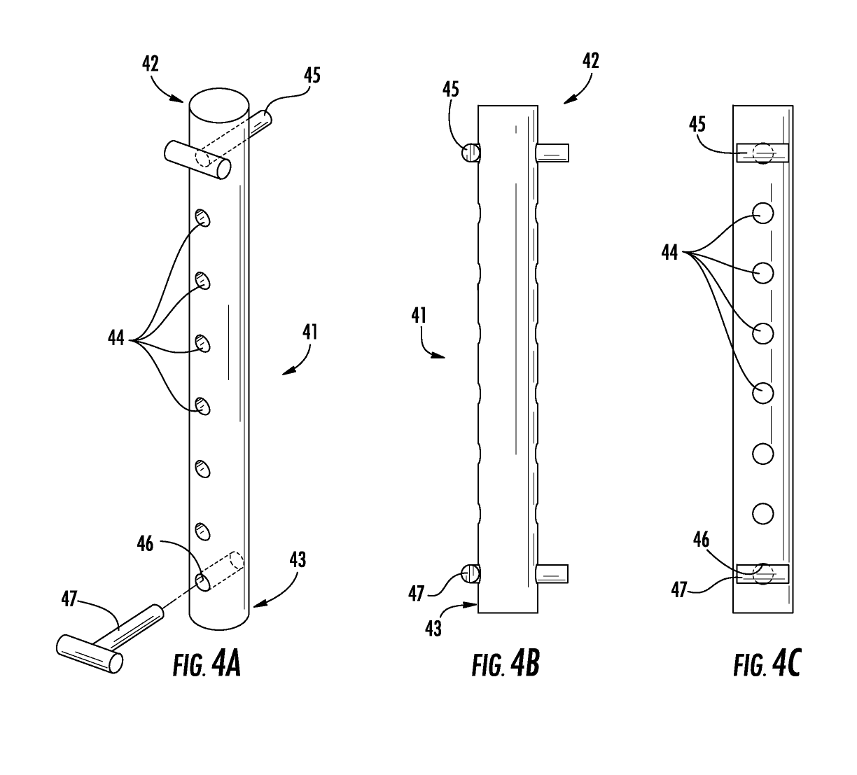

Referring to FIGS. 1, 4A, 4B, and 4C, a center pivot member 41 of the present invention is shown. The center pivot member 41 is designed to operationally engage the distal end 37 horizontal support member 35 of the support arm 31 and is vertically co-aligned with the center axis 91 and the center point 18 of the circular base 11. The center pivot member 41 comprising a top end 42, a bottom end 43, a plurality of horizontal height adjustment apertures 44 which are vertically aligned from the top end 42 of the center pivot member 41 to the bottom end 43 of the center pivot member 41, a height adjustment pin 45 that is operationally designed to be received by one of the horizontal height adjustment apertures 44 to engage the support pivot ring 38 to raise or lower the center pivot member 41, and a horizontal retaining pin aperture 46 is located at the bottom end 43 of the center pivot member 41. The horizontal retaining pin aperture 46 is operationally designed to receive a retaining pin 47.

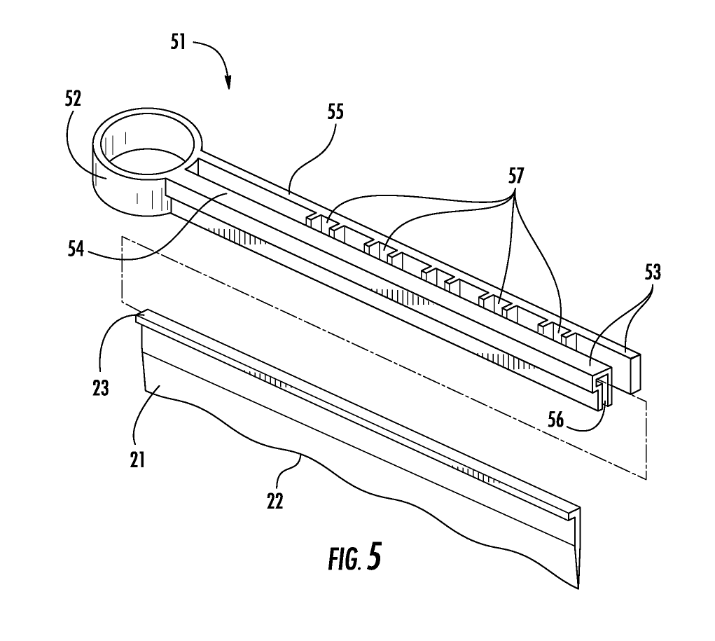

A preferred embodiment of present invention includes a horizontal icing member 51 as shown in FIG. 5. Now referring to FIGS. 1 and 5, the horizontal icing member 51 is operationally designed to engage the center pivot member 41 and to rotate radially above the cake 81. Continuing to refer to FIG. 5, the horizontal icing member 51 also includes a first icing blade 21 that has a first icing edge 22 and a first support element 23, a pivot ring 52 that is operationally designed to engage the center pivot member 41, a pair of parallel prongs 53 which extend laterally from the pivot ring 52, a first prong 54 of said parallel pair of prongs having a horizontal slot 56 that extends laterally from the pivot ring 52 and is configured to receive the first support element 23 of the first icing blade 21, the horizontal slot 56 being closed at the pivot ring 52, and a second prong 55 of said pair of parallel prongs 53 which has a plurality of horizontally aligned notches 57. The first icing edge 22 of the first icing blade 21 is designed to engage the layer of icing 84 on the top surface 82 of the cake 81 as the horizontal icing member 51 rotates radially. The first icing blade 21 can be manufactured from materials, or a combination of materials, such as but not limited to, rigid plastic, lightweight metal, and rubber with the first icing edge 22 having one of various shapes. For example, an icing blade with a straight icing edge can be used to produce a smooth surface on the top surface 82 of the cake 81 as the horizontal icing member 51 rotates radially about the top surface 82 of the cake 81. In similar fashion an icing blade which has notches, or other shapes, cut into the icing edge may be used to produce a layer of icing 84 with ridges as a decorative effect. Icing blades having icing edges with different shapes can be used to produce cakes with various types of decorative features depending on the design of the icing edge of the horizontal icing member 51 and the vertical icing member 61.

Referring to FIGS. 1, 6A and 6B, the present invention includes a vertical icing member 61 that detachably attaches to the horizontal icing member 51 and having a second icing blade 24 which includes a second icing edge 25 and a second support element 26 and a guiding means 66. The vertical icing member 61 is designed to circle the cake 81 permitting the second icing edge 25 of the second icing blade 24 to engage the layer of icing 84 on the side surface 83 of the cake 81. Similar to the above described first icing blade 21 and the first icing edge 22, the second icing blade 24 can be manufactured from materials, or a combination of materials, such as but not limited to, rigid plastic, lightweight metal, and rubber with the second icing edge 25 having one of various shapes. For example, an icing blade with a straight icing edge can be used to produce a smooth flat surface on the side surface 83 of the cake 81 as the vertical icing member 61 circles the cake 81 so that the second icing edge 25 can engage the layer of icing 84 on the side surface 83 of the cake. In similar fashion an icing blade which has notches, or other shapes, cut into the icing edge may be used to produce a layer of icing with ridges or other shape as a decorative effect. Icing blades having icing edges with different shapes can be used to produce cakes with various types of decorative features. Now referring to FIGS. 1, 5, 6A and 6B, the vertical icing member 61 further comprising a top end 62, a bottom end 63, a vertical channel 64 extending from the top end 62 of the vertical icing member 61 and to the bottom end 63 of the vertical icing member 61, and a plurality of vertically aligned height adjustment hooks 65 that are operationally designed to engage one of the notches 57 on the second prong 55 of the horizontal icing member 51. The vertical channel 64 is open at the top end 62 of the vertical icing member 61 to receive the second support element 26 of the second icing blade 24 and closed at the bottom end 63 of the vertical icing member 61 to secure the second icing blade 24. The guiding means 66 of the vertical icing member 61 includes, but is not limited to, a tapered bottom end, a wheel, and a roller bearing, with all such guiding means 66 being incorporated into the bottom end 63 of the vertical icing member 61.

The present invention also includes a method of using a cake icing device 10 depicted in FIGS. 1 to 6 comprising the steps of:

providing a cake icing device 10 comprising: a stationary circular base 11 having a perimeter 17 and a center point 18, the circular base 11 being designed to support a cylindrical cake 81 having a top surface 82 and a side surface 83 with each of said cake surfaces 82, 83 being covered with a layer of icing 84; a support arm 31 detachably attached at the perimeter 17 of the circular base 11 and designed to terminate at a center axis 91 above said cake 81, the support arm 31 comprising a vertical support member 32 with a proximal end 33 and a distal end 34 and a horizontal support member 35 with a proximal end 36 engaged to the distal end 34 of the vertical support member 32 and a distal end 37 located on the center axis 91 above the cake 81; a center pivot member 41 being designed to operationally engage the distal end 37 of the horizontal support member 35 of the support arm 31 and being vertically co-aligned with the center axis 91 and the center point 18 of the circular base 11; a horizontal icing member 51 operationally designed to engage the center pivot member 41 and to rotate radially above the cake 81 and having a first icing blade 21 which includes a first icing edge 22 and a first support element 23, the first icing edge 22 being designed to engage the layer of icing 84 on the top surface 82 of the cake 81; and a vertical icing member 61 detachably attached to the horizontal icing member 51 having a second icing blade 24 which includes second icing edge 25 and a second support element 26 and a guiding means 66, the vertical icing member 61 being designed to circle the cake 81 to engage the layer of icing 84 on the side surface 83 of the cake 81; applying a layer of icing 84 to a cylindrical cake 81, said cake 81 having a top surface 82 and a side surface 83; aligning and placing said cake 81 on the center point 18 of the circular base 11; selecting and securing a first icing blade 21 to the horizontal icing member 51; selecting and securing a second icing blade 24 to the vertical icing member 61; adjusting the height of the horizontal icing member 51 to permit the first icing edge 22 of the first icing blade 21 to contact the layer of icing 84 on the top surface 82 of said cake 81; adjusting the position of the vertical icing member 61 to permit the second icing edge 25 of the second icing blade 24 to contact the layer of icing 84 on the side surface 83 of the cake 81; and applying rotational torque to the center pivot member 41, whereby the first icing edge 22 of the first icing blade 21 of the horizontal icing member 51 rotates radially to engage the layer of icing 84 on the top surface 82 of the cake 81 and the second icing edge 25 of the second icing blade 24 circles the cake 81 to engage the layer of icing 84 on the side of the cake 81.

Referring to the method described above, in one embodiment the circular base 11 further comprising a top side 12 having a plurality of annular grooves 15 radiating from the center point 18 of the circular base 11, the annular grooves 15 being configured to engage the guiding means 66, a bottom side 13, a vertical side wall 14 connecting the top side 12 and the bottom side 13 of the circular base 11, and a female fastening means 16 operationally designed to detachably attach the proximal end 32 of the vertical support member 34 of the support arm 31 to the vertical side wall 14 of the circular base 11.

In one embodiment of the above method the support arm 31 further comprising a support pivot ring 38 located at the distal end 37 of the horizontal support member 35, and a male fastening means 39 located at the proximal end 33 of the vertical support member 32 being operationally designed to engage the female fastening means 16 on the circular base 11.

In another embodiment of the above method the center pivot member 41 comprising a top end 42, a bottom end 43, a plurality of horizontal height adjustment apertures 44 being vertically aligned from the top end 42 to the bottom end 43 of the center pivot member 41, a height adjustment pin 45 being operationally designed to be received by one of the horizontal height adjustment apertures 44 to engage the support pivot ring 38 to raise or lower the center pivot member 41, and a horizontal retaining pin aperture 46 located at the bottom end 43 of the center pivot member 41, the horizontal retaining pin aperture 46 being operationally designed to receive a retaining pin 47.

In another embodiment of the above method the horizontal icing member 51 further comprising a pivot ring 52 operationally designed to engage the center pivot member 41, a pair of parallel prongs 53 extending laterally from the pivot ring 52, a first prong 54 of said parallel pair of prongs having a horizontal slot 56 extending laterally from the pivot ring 52 and being configured to receive the first support element 23 of the first icing blade 21, the horizontal slot 56 being closed at the pivot ring 52, and a second prong 55 of said pair of parallel prongs 53 having a plurality of horizontally aligned notches 57.

Referring to the method described above, in one embodiment of the present invention the vertical icing member 61 further comprising a top end 62, a bottom end 63, a vertical channel 64 extending from the top end 62 of the vertical icing member 61 and to the bottom end 63, the channel being open at the top end 62 to receive the second support element 26 of the second icing blade 24 and closed at the bottom end 63 to secure the icing blade, and a plurality of vertically aligned height adjustment hooks 65 operationally designed to engage one of the notches 57 on the second prong 55 of the horizontal icing member 51.

In one embodiment of the above method the guiding means 66 is a wheel incorporated into the bottom end 63 of the vertical icing member 61. Other embodiments of the above method may include, but are not limited to, other guiding means 66 incorporated into the bottom end 63 of the vertical icing member 61 such as a tapered bottom end 63 of the vertical icing member 61 and a roller bearing.

Now referring to FIGS. 1 to 6 generally, to use the present invention to smooth the layer of icing or add decorative aspects to the layer of icing on a cylindrical cake 81, the user first applies a layer of icing 84 to the top surface 82 and to the side surface 83 of the cake 81. The cake 81 is centrally aligned with the center point 18 of the circular base 11 and placed on the circular base 11 of the present invention. The first icing blade 21 is selected by the user and is secured to horizontal icing member 51 by sliding the first support element 23 of the first icing blade 21 into the horizontal slot 56 of the first prong 54. Similarly, the second icing blade 24 is selected by the user and secured to the vertical icing member 61 by sliding the second support element 26 of the second icing blade 24 into the vertical channel 64 of the vertical icing member 61. The support arm 31 is next detachably attached to the circular base 11 by engaging the male fastening means 39 located at the proximal end 33 of the vertical support member 32 with the female fastening means 16 located within the vertical side wall 14 of the circular base 11. The center pivot member 41 is inserted into the support pivot ring 38 located at the distal end 37 of the horizontal support member 35. The height adjustment pin 45 is inserted into a selected horizontal height adjustment aperture 44 to engage the support pivot ring 38 so that the center pivot member 41 is co-aligned with the center axis 91 and the center point 18 on the circular base 11 above the cake 81.

Next, the pivot ring 52 of the horizontal icing member 51 is placed onto the bottom end 43 of the center pivot member 41 such that the first icing blade 21 is pointed towards the top surface 82 of the cake 81. The retaining pin 47 is next inserted into the horizontal retaining pin aperture 46 to secure the horizontal icing member 51 onto the center pivot member 41. The level of the horizontal icing member 51 is adjusted to a level at which the first icing edge 22 of the first icing blade 21 engages the layer of icing 84 on the top surface 82 of the cake 81 via the horizontal height adjustment apertures 44 and the height adjustment pin 45. The user next orients the vertical icing member 61 such that the second icing edge 25 of the second icing blade 24 vertically engages the side surface 83 of the cake 81. The user then engages the guiding means 66 located at the bottom end 63 of the vertical icing member 61 with the corresponding annular groove 15 on the circular base 11. The user detachably attaches the vertical icing member 61 to the horizontal icing member 51 by engaging the appropriate notch 57 and the appropriate vertically aligned hook 65 located on the vertical icing member 61. Once the horizontal icing member 51 and the vertical icing member 61 are properly positioned and secured, the user gently rotates the center pivot member 41 to direct the horizontal icing member 51 and the vertical icing member 61 across the cake surfaces 82, 83 as the guiding means follows the annular groove around the cake.

The cake icing device of the present invention provides various advantages over other devices presently used to apply and smooth the layer of icing on a cake. The present invention can be economically manufactured from plastic materials completely, or a combination of plastic, light-weight metal, and rubber. The minimum number of parts which comprise the present invention and the stationary aspect of the cake on the stationary circular base simplifies the assembly and the use of the cake icing device by the homemaker. The mechanical nature of the present invention provides the homemaker the opportunity to consistently make cakes with a more professional looking layer of icing. The present invention is operated by hand, and therefore its use, and location of use, does not require an electrical, or other, power source. The icing edges of the horizontal and the vertical icing blades can be designed with straight edges to simply smooth the layer of icing on a cake. Or, the icing edges can incorporate different size notches and shapes to add a decorative feature to the layer of icing on the cake as the cake icing device is used. Unlike a commercial and professional cake icing device which requires a dedicated space for its use, the cake icing device of the present invention can be easily disassembled and thoroughly cleaned after use and compactly stored until its next use. Additionally, the various parts of the present invention are designed to be adjustable in order to accommodate cakes of different heights and widths. These and other advantages will be apparent to the homemaker and non-professional baker when using the present invention.

Although preferred embodiments of the invention have been described using specific terms, devices, and methods, such description if for illustrative purposes only. The words used are words of description rather than of limitation. It is to be understood that changes and variations may be made by those of ordinary skill in the art without departing from the spirit or the scope of the present invention. In addition, it should be understood that aspects of the various embodiments may be interchanged, either in whole, or in part. Therefore, the spirit and scope of the invention should not be limited to the description of the preferred versions contained herein.

That which is claimed:

1. A cake icing device comprising:
a circular base having a perimeter and a center point, the circular base being designed to support a cylindrical cake having a top surface and a side surface with each of said cake surfaces being covered with a layer of icing;
a support arm detachably attached to the perimeter of the circular base and designed to terminate at a center axis above said cake, the support arm comprising a vertical support member with a proximal end and a distal end and a horizontal support member with a proximal end engaged to the distal end of the vertical support member and a distal end located at the center axis above the cake;
a center pivot member being designed to operationally engage the distal end of the horizontal support member of the support arm and being vertically co-aligned with the center axis and the center point of the circular base;
a horizontal icing member operationally designed to engage the center pivot member and to rotate radially above the cake and having a first icing blade which includes a first icing edge and a first support element, said icing edge of the first icing blade being designed to engage the layer of icing on the top surface of the cake; and
a vertical icing member detachably attached to the horizontal icing member having a second icing blade and a guiding means, the vertical icing member having a second icing edge and a second support element and being designed to circle the cake to engage the layer of icing on the side surface of the cake.

2. The cake icing device of claim 1, wherein said circular base further comprising a top side having a plurality of annular grooves radiating from the center point of the circular base, the annular grooves being configured to engage the guiding means, a bottom side, a vertical side wall connecting the top side and the bottom side of the circular base, and a female fastening means operationally designed to detachably attach the proximal end of the vertical support member of the support arm to the vertical side wall of the circular base.

3. The cake icing device of claim 1, wherein said support arm further comprising a support pivot ring located at the distal end of the horizontal support member, and a male fastening means located at the proximal end of the vertical support member being operationally designed to engage the female fastening means on the circular base.

4. The cake icing device of claim 1, wherein said center pivot member comprising a top end, a bottom end, a plurality of horizontal height adjustment apertures being vertically aligned from the top end to the bottom end of the center pivot member, a height adjustment pin being operationally designed to be received by one of the horizontal height adjustment apertures to engage the support pivot ring to raise or lower the center, pivot member, and a horizontal retaining pin aperture located at the bottom end of the center pivot member, the horizontal retaining pin aperture being operationally designed to receive a retaining pin.

5. The cake icing device of claim 1, wherein said horizontal icing member further comprising a pivot ring operationally designed to engage the center pivot member, a pair of parallel prongs extending laterally from the pivot ring, a first prong of said parallel pair of prongs having a horizontal slot extending laterally from the pivot ring and being configured to receive the first icing blade support element, the horizontal slot being closed at the pivot ring, and a second prong of said pair of parallel prongs having a plurality of horizontally aligned notches.

6. The cake icing device of claim 1, wherein said vertical icing member further comprising a top end, a bottom end, a vertical channel extending from the top end of the vertical icing member and to the bottom end of the vertical icing member, the vertical channel being open at the top end to receive the second support element of the second icing blade and closed at the bottom end to secure the second icing blade, and a plurality of vertically aligned height adjustment hooks operationally designed to engage one of the notches on the second prong of the horizontal icing member.

7. The cake icing device of claim 1, wherein the guiding means of said vertical icing member includes, but is not limited to, a tapered bottom end, a wheel, and a roller bearing, said guiding means being incorporated into the bottom end of the vertical icing member.

8. A cake icing device comprising:
a stationary circular base being designed to support a cylindrical cake having a top surface and a side surface with each of said cake surfaces being covered with a layer of icing,
a support arm detachably attached to the circular base and being designed to terminate at a center axis above the cake,
a center pivot member operationally designed to engage the support arm,
a bifurcated horizontal icing member operationally designed to engage the center pivot member and to rotate radially above the cake to engage the layer of icing on the top surface of the cake, and
a vertical icing member being detachably attached to the horizontal icing member and operationally designed to circle the cake to engage the layer of icing on the side surface of the cake,
the stationary circular base having a perimeter, a center point, atop side, a bottom side, a vertical side wall connecting the top side and bottom side, a female fastening means located within the vertical side wall of the circular base, and a plurality of annular grooves radiating from the center point on the top side the circular base,
the support arm being detachably attached to the perimeter of the circular base and comprising a vertical support member with a proximal end and a distal end and a horizontal support member with a proximal end engaged to the distal end of the vertical support member and a distal end located at the center axis above the cake, a support pivot ring located at the distal end of the horizontal support member, and a male fastening means located at the proximal end of the vertical support member being operationally designed to engage the female fastening means on the circular base,
the center pivot member comprising a top end, a bottom end, a plurality of horizontal height adjustment apertures being vertically aligned from the top end to the bottom end of the center pivot member, a height adjustment pin being operationally designed to be received by one of the horizontal apertures to engage the support pivot ring to raise or lower the center pivot member, a horizontal retaining pin aperture located at the bottom end of the center pivot member, the horizontal retaining pin aperture being operationally designed to receive a retaining pin, wherein said center pivot member being designed to operationally engage the distal end of the horizontal support member and being vertically co-aligned with the center axis and the center point of the circular base,
the bifurcated horizontal icing member having a first icing blade which includes a first icing edge and a first support element, said first icing edge having one of a plurality of shapes being designed to engage the layer of icing on the top surface of the cake, a pivot ring operationally designed to engage the center pivot member, a pair of parallel prongs extending laterally from the pivot ring, a first prong of said pair of parallel prongs being designed to receive the first icing blade, said horizontal slot extending laterally from the pivot ring and being configured to receive the first support element of the first icing blade, the horizontal slot being closed at the pivot ring, and a second prong of said parallel pair of prongs having a plurality of horizontally aligned notches, and
the vertical icing member comprising a second icing blade which includes a second icing edge having one of a plurality of shapes and a second support element, a top end, a bottom end, a plurality of vertically aligned height adjustment hooks designed to engage a selected notch on the second prong of the horizontal icing member, a vertical channel traversing the length of the vertical icing member, the channel being open at the top end of the vertical icing member to receive the second support element of the second icing blade and closed at the bottom end of the vertical icing member to secure the second icing blade within the channel, and a guiding means incorporated into the bottom end of the vertical icing member being operationally designed to engage one of the annular grooves, wherein the guiding means of said vertical icing member includes, but is not limited to, a tapered bottom end, a wheel, and a roller bearing.

9. The method of using a cake icing device comprising the steps of:
providing a cake icing device comprising:
a circular base having a perimeter and a center point, the circular base being designed to support a cylindrical cake having a top surface and a side surface with each of said cake surfaces being covered with a layer of icing, wherein said circular base being designed to remain stationary when the cake icing device is in use;
a support arm detachably attached to the perimeter of the circular base and designed to terminate at a center axis above said cake, the support arm comprising a vertical support member with a proximal end and a distal end and a horizontal support member with a proximal end engaged to the distal end of the vertical support member and a distal end located on the center axis above the cake;
a center pivot member being designed to operationally engage the distal end of the horizontal support member of the support arm and being vertically aligned on a center axis with the center point of the circular base;
a horizontal icing member operationally designed to engage the center pivot member and to rotate radially above the cake and having a first icing blade which includes a first icing edge and a first support element, said first icing edge having one of a plurality of shapes being designed to engage the layer of icing on the top surface of the cake; and
a vertical icing member detachably′ attached to the horizontal icing member having a second icing blade which includes a second icing edge having one of a plurality of shapes, a second support element, and a guiding means, the vertical icing member being designed to circle the cake to engage the layer of icing on the side surface of the cake;
applying a layer of icing to a cylindrical cake, said cake having a top surface and a side surface;
aligning and placing said cake on the center point of the circular base;
assembling the horizontal icing member with the first icing blade having the desired first icing edge;
assembling the vertical icing member with the second icing blade having the desire second icing edge;
adjusting the height of the horizontal icing member to permit the first icing edge of the first icing blade to contact the layer of icing on the top surface of said cake;
adjusting the position of the vertical icing member to permit the second icing edge of the second icing blade to contact the layer of icing on the side surface of the cake; and
rotating the center pivot member, wherein the first icing edge of the first icing blade of the horizontal icing member rotates radially to engage the layer of icing on the top surface of the cake and the second icing edge of the second icing blade circles the cake to engage the layer of icing on the side of the cake.

10. The method of claim 9, wherein said circular base further comprising a top side having a plurality of annular grooves radiating from the center point of the circular base, the annular grooves being configured to engage the guiding means, a bottom side, a vertical side wall connecting the top side and the bottom side of the circular base, and a female fastening means operationally designed to detachably attach the proximal end of the vertical support member of the support arm to the vertical side wall of the circular base.

11. The method of claim 9, wherein said support arm further comprising a support pivot ring located at the distal end of the horizontal support member, and a male fastening means located at the proximal end of the vertical support member being operationally designed to engage the female fastening means on the circular base.

12. The method of claim 9, wherein said center pivot member comprising a top end, a bottom end, a plurality of horizontal height adjustment apertures being vertically aligned from the top end to the bottom end of the center pivot member, a height adjustment pin being operationally designed to be received by one of the horizontal apertures to engage the support pivot ring to raise or lower the center pivot member, and a horizontal retaining pin aperture located at the bottom end of the center pivot member, the horizontal retaining pin aperture being operationally designed to receive a retaining pin.

13. The method of claim 9, wherein said horizontal icing member further comprising a pivot ring operationally designed to engage the center pivot member, a pair of parallel prongs extending laterally from the pivot ring, a first prong of said parallel pair of prongs having a horizontal slot extending laterally from the pivot ring and being configured to receive the first support element of the first icing blade, the horizontal slot being closed at the pivot ring, and a second prong of said pair of parallel prongs having a plurality of horizontally aligned notches.

14. The method of claim 9, wherein said vertical icing member further comprising a top end, a bottom end, a vertical channel extending from the top end of the vertical icing member to the bottom end, the channel being open at the top end to receive the second support element of the second icing blade and closed at the bottom end to secure the second icing blade, and a plurality of vertically aligned height adjustment hooks operationally designed to engage one of the notches on the second prong of the horizontal icing member.

15. The method of claim 9, wherein the guiding means of said vertical icing member includes, but is not limited to, a tapered bottom end, a wheel, and a roller bearing, said guiding means being incorporated into the bottom end of the vertical icing member.
